(19) United States
(12) Patent Application Publication
(10) Pub. No.: US 2006/0112171 A1
(43) Pub. Date: May 25, 2006

(54) System and method to control devices using a remote control device via hypertext transfer protocol (HTTP)

(76) Inventor: Shawn T. Rader, Hillsboro, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/994,041

(22) Filed: Nov. 19, 2004

(51) Int. Cl. G06F 15/16

(52) U.S. Cl. 709/218

(57) ABSTRACT

A method and system for remotely controlling a device by using a remote control device via Hypertext Transfer Protocol (HTTP) have been described. An embodiment of the method includes receiving a request to remotely control a target device from a Web browser in a remote control device. A Web page is then sent to the Web browser, where the Web page is used to control the target device. Commands are received from the Web browser via the Web page to remotely control the target device.

### BACKGROUND

The importance for the consumer electronic device industry to continuously strive to produce products that are convenient to use cannot be overstated. No doubt this is one of the reasons for the introduction of the remote control device. But, as the number of devices in a home that can be controlled remotely continues to grow, so does the frustration of trying to keep each device's remote control separate from other devices' remote controls. For example, today's homes may have a separate remote control device for its television, digital video disk (DVD) player, video cassette recorder (VCR) player, compact disk (CD) player, set-top box, stereo receiver, media center, personal video recorder (PVR), etc. Trying to keep this many remote controls separate and easily locatable is not only a challenge but also reduces the ease and convenience of use of each of the electronic devices.

One attempt at a solution to the problem of having so many different remote controls is the universal remote control. Existing universal remote controls have several problems. First, they rely on storing infrared (IR) codes for every specific model of consumer electronics device in existence. With the number of consumer electronics devices available it is virtually impossible for a universal remote control manufacturer to cover the proprietary IR codes for every device on the market. In addition, unless the universal remote control allows for end user updates it will not be able to control future devices that are released after the production date of the original universal remote control. Another limitation of existing IR universal remote controls is that they are designed to support an existing feature set, and are not extensible to control future features unless provided with a mechanism to allow user updates.

### BRIEF DESCRIPTION OF THE DRAWINGS

The invention may be best understood by referring to the following description and accompanying drawings that are used to illustrate embodiments of the invention. In the drawings:

FIG. 1 illustrates one embodiment of an environment for controlling devices using a remote control device via Hypertext Transfer Protocol (HTTP), in which some embodiments of the present invention may operate;

FIG. 2 illustrates an example Web page that may be utilized to remotely control a device according to an embodiment of the invention;

FIG. 3 is a flow diagram of one embodiment of a process for the operation of a remote control device to control a target device;

FIG. 4 is a flow diagram of one embodiment of a process for the operation of a target device; and

FIG. 5 illustrates one embodiment of an environment for controlling devices using a remote control device via Hypertext Transfer Protocol (HTTP), in which some embodiments of the present invention may operate.

### DESCRIPTION OF EMBODIMENTS

A method and system for remotely controlling a device by using a remote control device via Hypertext Transfer Protocol (HTTP) are described. Here, at least some of the problems described above may be alievated by moving the interfaces to control an electronic device (via a Web page) into the device itself and allow the user's remote control device to access these interfaces through the use of an Internet Web browser.

In an embodiment of the invention, one or more electronic devices implement a HTTP server and a Transmission Control Protocol/Internet Protocol (TCP/IP) capable network connection. The HTTP server includes a Web page or interface that allows the user to configure the device, view the device's current status (e.g., settings) and perform all the functionality that would normally be performed through a typical IR remote control device. This Web page is downloaded onto a remote control device, where the remote control device is any networked device running a Web browser. The remote control device running the Web browser may be a personal digital assistant (PDA), laptop, Web enabled mobile phone, personal computer, or other device capable of running a Web browser. Once the Web page is loaded into the user's Web browser, the user is able to control the device via the Web page in a similar manner as a typical IR remote control device. In the following description, for purposes of explanation, numerous specific details are set forth. It will be apparent, however, to one skilled in the art that embodiments of the invention can be practiced without these specific details.

In the following detailed description of the embodiments, reference is made to the accompanying drawings that show, by way of illustration, specific embodiments in which the invention may be practiced. In the drawings, like numerals describe substantially similar components throughout the several views. These embodiments are described in sufficient detail to enable those skilled in the art to practice the invention. Other embodiments may be utilized and structural, logical, and electrical changes may be made without departing from the scope of the present invention.

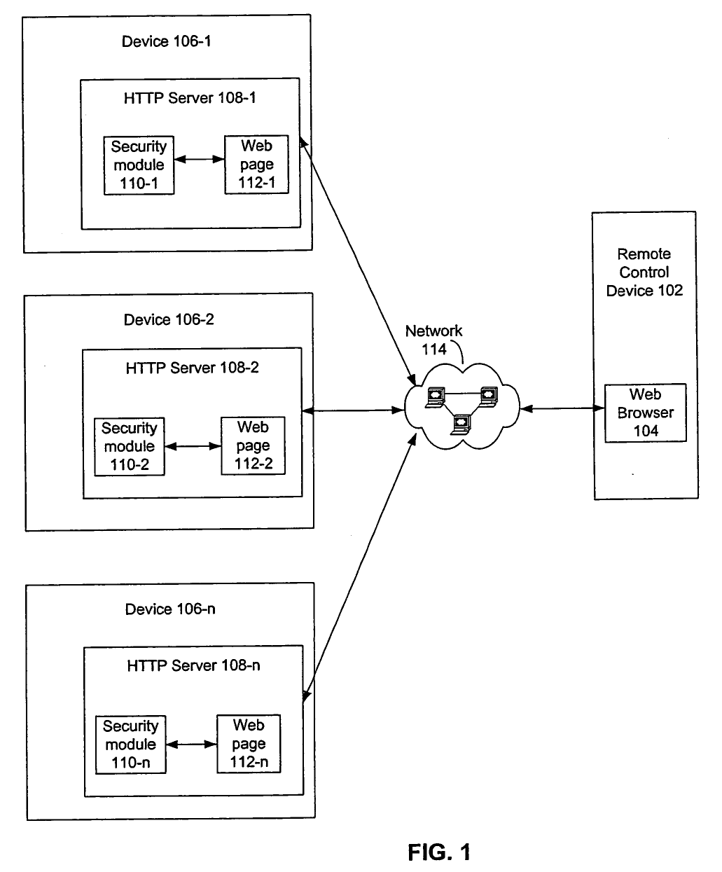

FIG. 1 illustrates one embodiment of an environment for controlling devices using a remote control device via HTTP, in which some embodiments of the present invention may operate. The specific components shown in FIG. 1 represent one example of a configuration that may be suitable for the invention and is not meant to limit the invention.

Referring to FIG. 1, the environment for controlling devices using a remote control device via HTTP may include, but is not necessarily limited to, a remote control device 102, one or more devices 106 (shown as devices 106-1 through 106-n), and a network 114. Remote control device 102 is any device capable of running a Web browser and thus includes, but is not necessarily limited to, a Web browser 104. Each device 106 may include, but is not necessarily limited to, a HTTP server 108 (shown as HTTP servers 108-1 through 108-n). Each HTTP server 108 may include, but is not necessarily limited to, a security module 110 (shown as security modules 110-1 through 110-n) and a Web page or interface 112 (shown as Web pages 112-1 through 112-n). Each of these components will be described below in more detail.

In an embodiment not meant to limit the invention, remote control device 102 and devices 106 are networked together via network 114. In an embodiment, network 114 may be an 802.11 wireless network. Network 114 may also be a wired network that uses IEEE 1394 or firewire to connect the various components. Other networks may be added or substituted according to the particular application for the environment in FIG. 1 and/or as new types of networks are developed. These example types of networks are not meant to limit the invention.

Remote control device 102 is any networked device running Web browser 104. For example, remote control device 102 could be, but is not limited to, a laptop, a personal computer, a personal digital assistant (PDA), a Web enabled mobile phone, and so forth. Web browser 104 may be any application that is used to locate and display Web pages. Although only one remote control device 102 is shown in FIG. 1, the present invention is not limited to this. Embodiments of the invention allow multiple users to concurrently use their remote control devices 102 to operate different networked devices 106. For example, a father could use his remote control device 102 to operate the CD player at the same time his son is using his remote control device to operate the television. In an embodiment of the invention, if two different remote control devices 102 are used at the same time to operate the same networked device 106, then only the first request for use gets through to device 106.

Devices 106 may be any electronic device capable of implementing HTTP server 108 and a TCP/IP capable network connection (not shown in FIG. 1). In an embodiment of the invention not meant to limit the invention, devices 106 contain a network controller such as an 802.11 wireless network connection. Examples of devices 106 include, but are not limited to, a television, a DVD player, a VCR player, a CD player, a set-top box, a stereo receiver, a media center, a PVR, and so forth. The present invention is not limited to typical devices found in a home. Although there are n devices 106 shown in FIG. 1, the present invention may include one or more devices.

HTTP server 108 may include security module 110 and Web page 112. Security module 110 determines whether a particular user should have access to Web page 112 and thus be able to control device 106. Security module 110 may be implemented as a password query, a secure public/private key encryption method, a Secure Sockets Layer (SSL) and/or Secure HTTP (S-HTTP) which are existing security technologies commonly available in Web browsers and so forth. These examples are not meant to limit the invention.

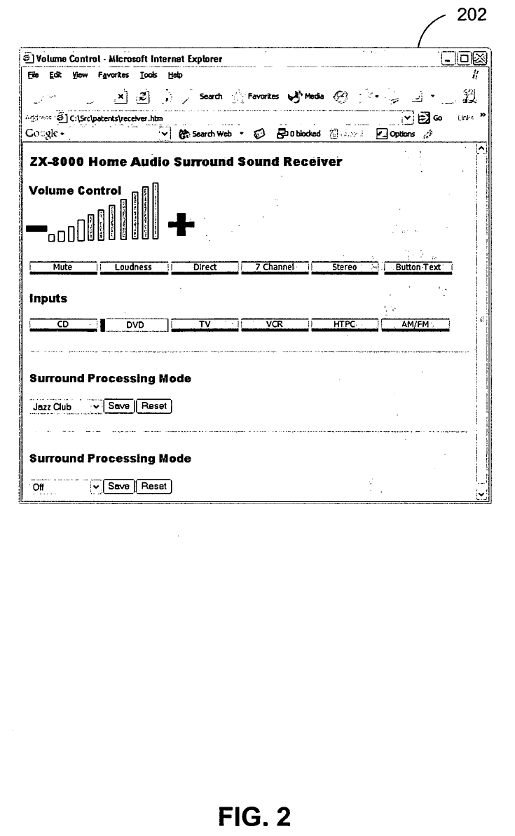

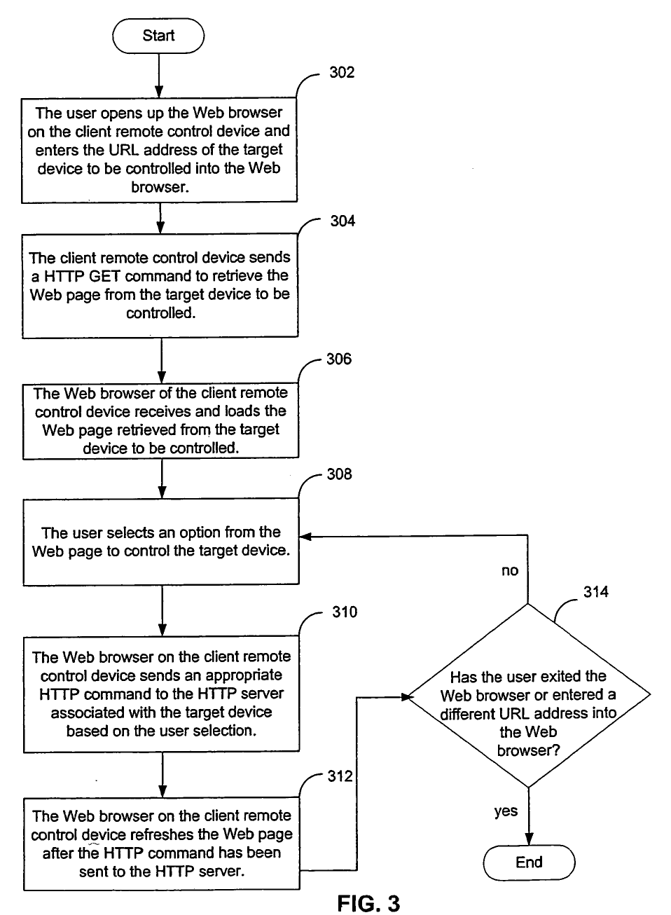

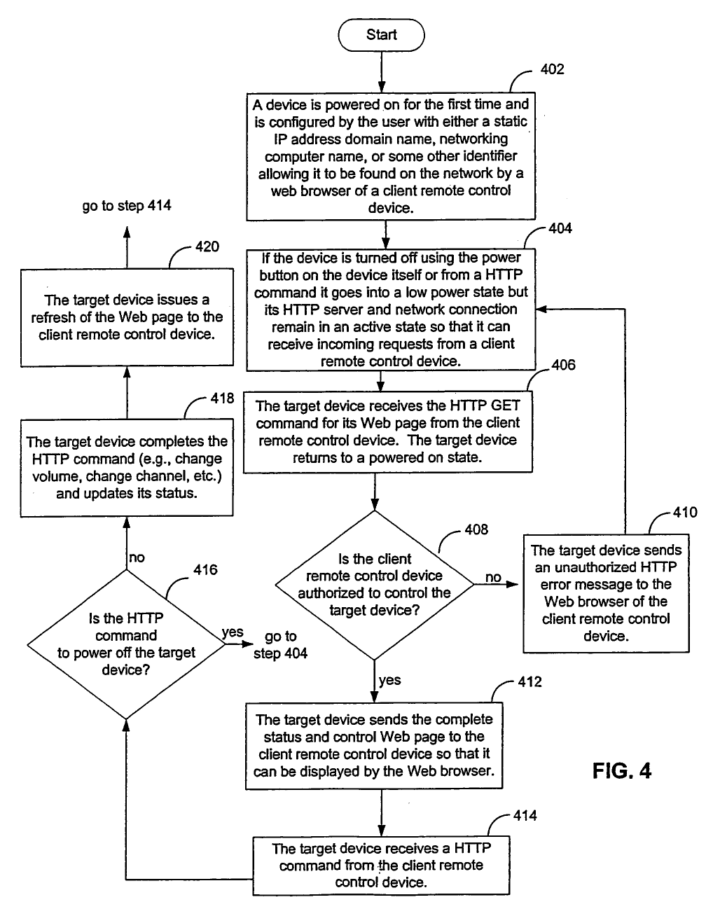

Web page 112 allows the user to configure device 106, view its current status (e.g., settings) and perform all the functionality that would normally be performed through a typical IR remote control device. Referring to FIG. 2, an example Web page for a home audio surround sound receiver is shown. Here, a user may access example Web page 202 at his or her Web browser 104 on remote control device 102 to control the receiver's volume, inputs and surround processing mode. This example is not meant to limit the invention. Embodiments of the operation of the present invention are described next in more detail with reference to the flow diagrams of FIGS. 3 and 4.

FIG. 3 is a flow diagram of one embodiment of a process for the operation of a client remote control device to control a target device. Referring to FIG. 3, the process begins at processing block 302 where the user opens up the Web browser (such as Web browser 104 of FIG. 1) on the client remote control device (such as device 102 of FIG. 1). The user then enters the uniform resource locator (URL) address of the target device (such as one of devices 106-1 through 106-n) to be controlled into the Web browser.

At processing block 304, the client remote control device sends a HTTP GET command to retrieve the Web page (such as Web page 112 from FIG. 1) from the target device. At processing block 306, the Web browser of the client remote control device receives and loads the Web page retrieved from the target device. At processing block 308, the user selects an option from the Web page to control the target device.

At processing block 310, the Web browser on the client remote control device sends an appropriate HTTP command to the HTTP server (such as HTTP server 108 of FIG. 1) associated with the target device based on the user selection. At processing block 312, the Web browser on the client remote control device refreshes the Web page after the HTTP command has been sent to the HTTP server.

At decision block 314, it is determined whether the user has exited the Web browser or entered a different URL address into the Web browser. If so, then the user is finished remotely controlling the target device and the flow diagram of FIG. 3 ends. Alternately, control passes back to processing block 308 where the Web browser waits for the user to select another option.

FIG. 4 is a flow diagram of one embodiment of a process for the operation of the target device. Referring to FIG. 4, the process begins at processing block 402 where a device (such as one of devices 106-1 through 1-6-n of FIG. 1) is powered on for the first time and is configured by the user with either a static IP address domain name, a networking computer name, or some other identifier allowing the device to be found on a network (such as network 114 of FIG. 1) by a Web browser (such as Web browser 104 of FIG. 1) of a client remote control device (such as device 102 of FIG. 1).

At processing block 404, if the device is turned off using the power button on the device itself or from a HTTP command, the device goes into a low power state but its HTTP server and network connection remain in an active state so that it can receive incoming requests or commands from the client remote control device. At processing block 406, the target device receives the HTTP GET command from the client remote control device for its control Web page. The target device returns to a powered on state.

At decision block 408, it is determined whether the client remote control device is authorized to control the target device. If not, then control passes to processing block 410 where the target device sends an “unauthorized HTTP error message” (or some other message indicating the client remote control device does not have access to control the target device) to the Web browser of the client remote control device. Control then passes back to step 404 where the device goes back into a low power state.

Alternatively, if in decision block 408 it is determined that the client remote control device is authorized to control the target device, then control passes to processing block 412. At processing block 412, the target device sends its status and control Web page to the client remote control device so that it can be displayed by its Web browser. At processing block 414, the target device receives a HTTP command from the client remote control device.

At decision block 416, it is determined whether the HTTP command is a command to power off the target device. If so, then control passes back to processing block 404 where the target devices goes back into a low power state. Alternatively, if it is determined that the HTTP command is a command to control the target device, then control passes to processing block 418. At processing block 418, the target device completes the HTTP command (e.g., changes volume, changes channel, and so forth) and updates its status. In processing block 420, the target device issues a refresh of the Web page to the client remote control device. The control of FIG. 4 goes back to processing block 414 where the target device waits for another HTTP command from the client remote device.

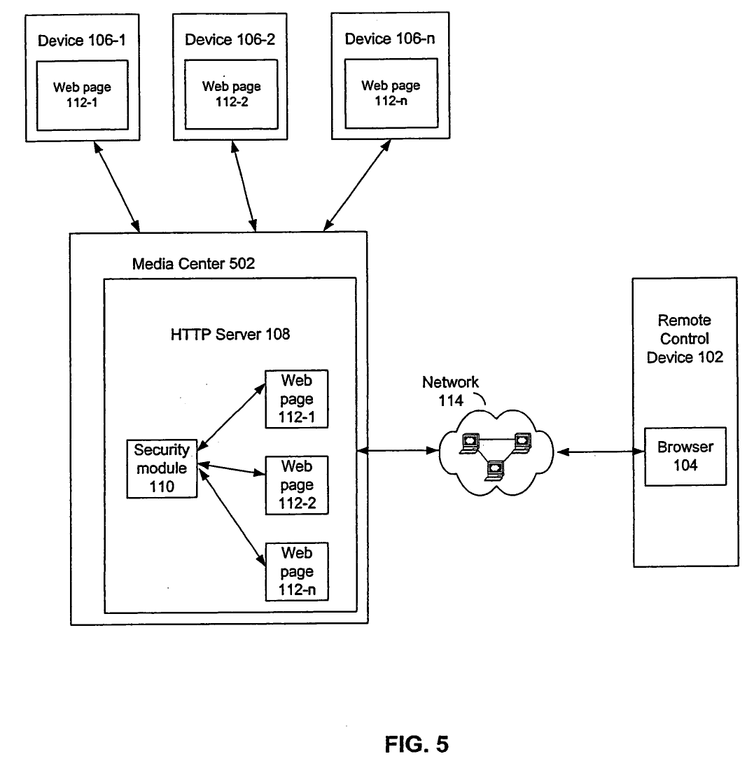

FIG. 5 illustrates one embodiment of an environment for controlling devices using a remote control device via Hypertext Transfer Protocol (HTTP), in which some embodiments of the present invention may operate. In the embodiment shown in FIG. 5 a media center 502 implements a HTTP server 108 and a TCP/IP capable network connection instead of each of devices 106-1 through 106-n (as described in FIG. 1). Here, media center 502 acts as a gateway for a user via remote control device 102 to control any of devices 106-1 through 106-n by storing a copy of each the device web pages 112-1 though 112-n in its HTTP server 108. In FIG. 5, one security module 110 may control access to all of Web pages 112-1 through 112-n.

In FIG. 5, each device 106-1 through 106-n stores a copy of its own Web page 112 in nonvolatile memory and may be accessible by another device to which it is connected. Each of the connections between media center 502 and devices 106-1 through 106-n create a sub-network, where the sub-network functions as part of network 114. The connections between media center 502 and devices 106-1 through 106-n may be implemented as a IEEE 802.X based Ethernet network, a digital connection such as IEEE 1394 or High-Bandwidth Digital Content Protection (HDCP), and so forth. In the embodiment illustrated in FIG. 5, the sub-network allows Web pages 112-1 through 112-n to be transmitted to remote control device 102 via network 114 and thus appear to the user to be stored on network 114.

Embodiments of the present invention may be implemented in software, firmware, hardware or by any combination of various techniques. For example, in some embodiments, the present invention may be provided as a computer program product or software which may include a machine or computer-readable medium having stored thereon instructions which may be used to program a computer (or other electronic devices) to perform a process according to the present invention. In other embodiments, steps of the present invention might be performed by specific hardware components that contain hardwired logic for performing the steps, or by any combination of programmed computer components and custom hardware components.

Thus, a machine-readable medium may include any mechanism for storing or transmitting information in a form readable by a machine (e.g., a computer). These mechanisms include, but are not limited to, a hard disk, floppy diskettes, optical disks, Compact Disc, Read-Only Memory (CD-ROMs), magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, a transmission over the Internet, electrical, optical, acoustical or other forms of propagated signals (e.g., carrier waves, infrared signals, digital signals, etc.) or the like.

Some portions of the detailed descriptions above are presented in terms of algorithms and symbolic representations of operations on data bits within a computer system's registers or memory. These algorithmic descriptions and representations are the means used by those skilled in the data processing arts to convey the substance of their work to others skilled in the art most effectively. An algorithm is here, and generally, conceived to be a self-consistent sequence of operations leading to a desired result. The operations are those requiring physical manipulations of physical quantities. Usually, although not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussions, it is appreciated that discussions utilizing terms such as “processing” or “computing” or “calculating” or “determining” or the like, may refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Reference throughout this specification to “one embodiment” or “an embodiment” means that a particular feature, structure, or characteristic described in connection with the embodiment is included in at least one embodiment of the invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

What is claimed is:

1. A method comprising:
receiving a request to remotely control a target device from a Web browser in a remote control device, wherein the remote control device is any networked device running the Web browser;
sending a Web page to the Web browser, wherein the Web page is used to control the target device; and
receiving commands from the Web browser via the Web page to remotely control the target device.

2. The method of claim 1, wherein the target device is any networked device capable of implementing a Hypertext Transfer Protocol (HTTP) server.

3. The method of claim 2, wherein the target device includes a wireless network connection.

4. The method of claim 1, wherein the remote control device is one of a laptop, a personal computer, a personal digital assistant (PDA) and a Web enabled mobile phone.

5. The method of claim 1, wherein the target device and the remote control device are networked together via an 802.11 network.

6. The method of claim 1, wherein the target device and the remote control device are networked together via a firewire network.

7. The method of claim 1, wherein the target device includes a Hypertext Transfer Protocol (HTTP) server, wherein the HTTP server includes a security module and the Web page and wherein the security module is used to determine whether a user has access rights to the Web page.

8. A method comprising:
sending a request via a Web browser in a remote control device to control a target device, wherein the remote control device is any networked device running the Web browser;
in response to the request from the Web browser, receiving a Web page from the target device; and
allowing a user to enter a command into the Web page, wherein the command is used to remotely control the target device.

9. The method of claim 8, wherein the target device is any networked device capable of implementing a Hypertext Transfer Protocol (HTTP) server.

10. The method of claim 9, wherein the target device includes a wireless network connection.

11. The method of claim 8, wherein the remote control device is one of a laptop, a personal computer, a personal digital assistant (PDA) and a Web enabled mobile phone.

12. The method of claim 8, wherein the target device and the remote control device are networked together via an 802.11 network.

13. The method of claim 8, wherein the target device and the remote control device are networked together via a firewire network.

14. The method of claim 8, wherein the target device includes a Hypertext Transfer Protocol (HTTP) server, wherein the HTTP server includes a security module and the Web page and wherein the security module is used to determine whether a user has access rights to the Web page.

15. A remote control device comprising a Web browser, wherein the remote control device is any networked device running a Web browser and wherein the remote control device sends a command to remotely control a target device via the Web browser.

16. The remote control device of claim 15, wherein the remote control device receives a Web page from the target device, wherein the command to control the target device is entered into the Web page.

17. The remote control device of claim 15, wherein the remote control device is one of a laptop, a personal computer, a personal digital assistant (PDA) and a Web enabled mobile phone.

18. The remote control device of claim 15, wherein the target device and the remote control device are networked together via an 802.11 network.

19. The remote control device of claim 15, wherein the target device and the remote control device are networked together via a firewire network.

20. A system comprising:
a media center, wherein the media center is connected to at least one target device, wherein the media center stores a Web page used to control the at least one target device, wherein the media center receives a request to remotely control the at least one target device from a Web browser in a remote control device, wherein the remote control device is any networked device running the Web browser, wherein the media center sends the Web page to the Web browser and wherein the media center receives commands from the Web browser via the Web page to remotely control the at least one target device.

21. The system of claim 20, wherein the media center is capable of implementing a Hypertext Transfer Protocol (HTTP) server.

22. The system of claim 21, wherein the media center includes a wireless network connection.

23. The system of claim 20, wherein the remote control device is one of a laptop, a personal computer, a personal digital assistant (PDA) and a Web enabled mobile phone.

24. The system of claim 20, wherein the media center and the remote control device are networked together via an 802.11 network.

25. The system of claim 20, wherein the media center and the remote control device are networked together via a firewire network.

26. The system of claim 20, wherein the media center includes a Hypertext Transfer Protocol (HTTP) server, wherein the HTTP server includes a security module and the Web page and wherein the security module is used to determine whether a user has access rights to the Web page.

27. A machine-readable medium containing instructions which, when executed by a processing system, cause the processing system to perform a method, the method comprising:
receiving a request to remotely control a target device from a Web browser in a remote control device, wherein the remote control device is any networked device running the Web browser;
sending a Web page to the Web browser, wherein the Web page is used to control the target device; and
receiving commands from the Web browser via the Web page to remotely control the target device.

28. The machine-readable medium of claim 27, wherein the target device is any networked device capable of implementing a Hypertext Transfer Protocol (HTTP) server.

29. The machine-readable medium of claim 27, wherein the target device includes a wireless network connection.

30. The machine-readable medium of claim 27, wherein the remote control device is one of a laptop, a personal computer, a personal digital assistant (PDA) and a Web enabled mobile phone.

31. The machine-readable medium of claim 27, wherein the target device and the remote control device are networked together via an 802.11 network.

32. The machine-readable medium of claim 27, wherein the target device and the remote control device are networked together via a firewire network.

33. The machine-readable medium of claim 27, wherein the target device includes a Hypertext Transfer Protocol (HTTP) server, wherein the HTTP server includes a security module and the Web page and wherein the security module is used to determine whether a user has access rights to the Web page.
